(19) United States
(12) Patent Application Publication
(10) Pub. No.: US 2026/0002070 A1
(43) Pub. Date: Jan. 1, 2026

(54) SOFTENING OF PRODUCED OILFIELD BRINES

(71) Applicant: Saudi Arabian Oil Company, Dhahran (SA)

(72) Inventors: Salem Alshammari, Dhahran (SA); Hussain Habib Al Saleem, Qatif-Tarout (SA); Salah Hamad Al-Saleh, Dhahran (SA); Subhash Ayirala, Dhahran (SA); Ali Yousef, Dhahran (SA)

(21) Appl. No.: 18/760,953

(22) Filed: Jul. 1, 2024

(51) Int. Cl. C09K 8/58; C02F 5/06; C02F 103/36

(52) U.S. Cl. CPC C09K 8/58; C02F 5/06; C02F 2103/365

(57) ABSTRACT

Method for softening produced oilfield brine for enhanced oil recovery, the method including dissolving gaseous carbon dioxide and a base in a produced oilfield brine that includes divalent ions to yield solid carbonates, filtering the solid carbonates to yield a softened water, and injecting the softened water into a subterranean formation.

### TECHNICAL FIELD

This document relates to methods of softening produced oilfield brines for CO₂ mineralization and enhanced oil recovery.

### BACKGROUND

Produced water from oil and gas fields is rich in divalent cations, for example calcium and magnesium. Produced water is typically a waste product due to the high concentration of divalent cations, which can be corrosive in industrial processes or environmentally damaging in agricultural processes. Modifying the produced brine to be suitable for subsequent applications, such as in enhanced oil recovery, would be beneficial.

### SUMMARY

This disclosure describes methods for softening produced oilfield brine for enhanced oil recovery.

In some embodiments, a method for softening produced oilfield brine for enhanced oil recovery includes dissolving gaseous carbon dioxide (CO₂) in a produced oilfield brine, wherein the produced oilfield brine comprises divalent ions, to yield a CO₂ charged water, adding a base to the CO₂ charged water to yield a basic CO₂ charged slurry, wherein the basic CO₂ charged slurry comprises solid carbonates, filtering the basic CO₂ charged slurry to remove the solid carbonates to yield a softened water, and injecting the softened water into a subterranean formation.

The details of one or more implementations of the disclosure are set forth in the accompanying drawings and the description that follows. Other features, objects, and advantages of the disclosure will be apparent from the description and drawings, and from the claims.

### DESCRIPTION OF DRAWINGS

FIG. 1 is a flow chart of an example method of softening produced oilfield brine for enhanced oil recovery.

FIG. 2 shows an example XRD spectra of precipitated salt.

Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure are methods for softening produced brine via carbon dioxide sequestration, where the softened produced brine is further utilized in enhanced oil recovery.

Produced brine is a water-based solution that is produced as a byproduct during oil and/or natural gas extraction. Produced water from oil and gas fields is rich in divalent cations, for example, calcium and magnesium. These brines can be exploited for CO₂ sequestration by mineralizing CO₂ with calcium and magnesium ions to yield calcium carbonate and/or magnesium carbonate. Beneficially, CO₂ mineralization has a negative carbon footprint.

CO₂ mineralization includes introducing gaseous CO₂ to a produced oilfield brine, for example by bubbling the gas through the brine. Gaseous carbon dioxide will dissolve in an aqueous solution, for example, produced oilfield brine, to form aqueous carbon dioxide. At low pH, for example, a pH between 3.8 and 4.8, the aqueous carbon dioxide will react with protons to form carbonic acid, as shown in Equation 1. When a base is added, the carbonic acid is deprotonated to yield carbonate ions, as shown in Equation 2. The carbonate ions can then react with calcium ions to form calcium carbonate, as shown in Equation 3, and with magnesium ions to form magnesium carbonate, as shown in Equation 4. In some embodiments, a catalyst can be used to increase the rate of mineralization, i.e., the rate of the reactions shown in Equations 3 and 4.

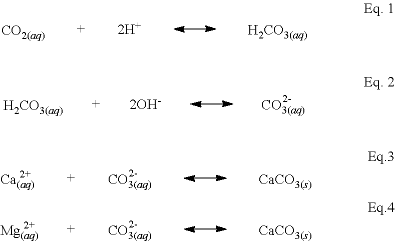

In addition to sequestering excess CO₂ that might have otherwise been released into the atmosphere, the removal of calcium and magnesium softens the produced brine, which can then be used for additional processes. Softening produced brine can also prevent scale formation and corrosion, which can occur when utilizing the un-softened (i.e., hard) water in industrial processes. As described herein, the softened produced brine is utilized in subsequent enhanced oil recovery operations. For example, the softened produced brine can be utilized in water flooding. Water flooding is a technique in oil recovery where water is injected into subterranean reservoirs in order to maintain the pressure in the formation by replacing extracted fluids. Injection of brines that contain a high concentration of divalent ions can cause formation damage through precipitation reactions that block the rock pores. This blockage negatively affects the injectivity of the formation. Therefore, injecting divalent ion-free water can mitigate the risk of blockage formation and improve the water flooding process.

A method of softening produced brine for enhanced oil recovery includes dissolving gaseous carbon dioxide in a produced oilfield brine, wherein the produced oilfield brine includes divalent ions, to yield a CO₂ charged water. In some embodiments, the divalent ions include calcium ions. In some embodiments, the divalent ions include magnesium ions. In some embodiments, the CO₂ charged water has a pH of between 3.8 to 4.8. The method includes adding a base to the CO₂ charged water to yield a basic CO₂ charged slurry. The basic CO₂ charged slurry includes solid carbonates. In some embodiments, the base includes NH₃OH, NaOH, Na₂[B₄O₅(OH)₄]·8H₂O, or Na₃PO₄. In some embodiments, the basic CO₂ charged slurry has a pH of greater than 4.8. In some embodiments, the solid carbonates include calcium carbonates. In some embodiments, the solid carbonates include magnesium carbonates. In some embodiments, the method includes adding a catalyst to the basic CO₂ charged slurry. The method includes filtering the basic CO₂ charged slurry to remove the solid carbonates and yield a softened water. The softened water is injected into a subterranean formation. In some embodiments, the method includes displacing oil in a subterranean formation with the softened water. In some embodiments, the method includes recovering the displaced oil from the subterranean formation.

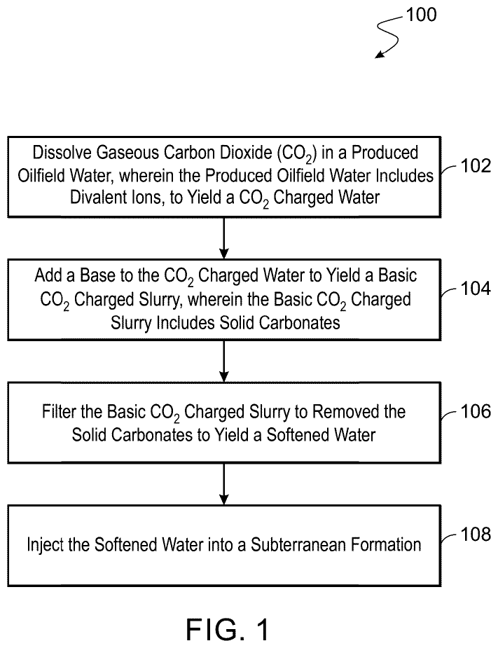

FIG. 1 is a flow chart of an example method 100 of softening produced oilfield brine for enhanced oil recovery. At 102, gaseous carbon dioxide (CO₂) is dissolved in a produced oilfield brine to yield a CO₂ charged water. The produced oilfield brine includes divalent cations. In some embodiments, the divalent ions include calcium ions. In some embodiments, the divalent ions include magnesium ions. In some embodiments, the CO₂ charged water has a pH of between 3.8 to 4.8. At 104, a base is added to the CO₂ charged water to yield a basic CO₂ charged slurry. The basic CO₂ charged slurry includes solid carbonates. In some embodiments, the base includes NH₃OH, NaOH, Na₂[B₄O₅ (OH)₄]·8H₂O, or Na₃PO₄. In some embodiments, the basic CO₂ charged slurry has a pH of greater than 4.8. In some embodiments, the solid carbonates include calcium carbonates. In some embodiments, the solid carbonates include magnesium carbonates. In some embodiments, the method includes adding a catalyst to the basic CO₂ charged slurry. At 106, the basic CO₂ charged slurry is filtered to remove the solid carbonates and yield a softened water. At 108, the softened water is injected into a subterranean formation. In some embodiments, the method includes displacing oil in a subterranean formation with the softened water. In some embodiments, the method includes recovering the displaced oil from the subterranean formation.

### Example 1: CO₂ Mineralization in Produced Brine

A 500 mL sample of produced brine was placed in a 1.00 L beaker. CO₂ gas was purged into the produced brine. The flow of the CO₂ gas was controlled using a pressure and flow regulator through which the flow was set to 1 liter per minute. In-situ pH and temperature readings were taken throughout the process to monitor the state of dissolved carbons. As the gas is purged into the produced brine, the pH decreased to about 3.8-4.8 due to the hydration of carbonic acid.

While the CO₂ was being purged into the produced brine sample, alkali (NH₃OH) was added to the reaction. The reaction was stirred at a rate of 300 rpm using a 70 mm stirring magnet bar. The rate limiting step is hydration of CO₂ to carbonic acid. Accordingly, a pH meter can be used to monitor the progress of the reaction. After reaching equilibrium, the solution was filtered using a 0.45 μm filter paper.

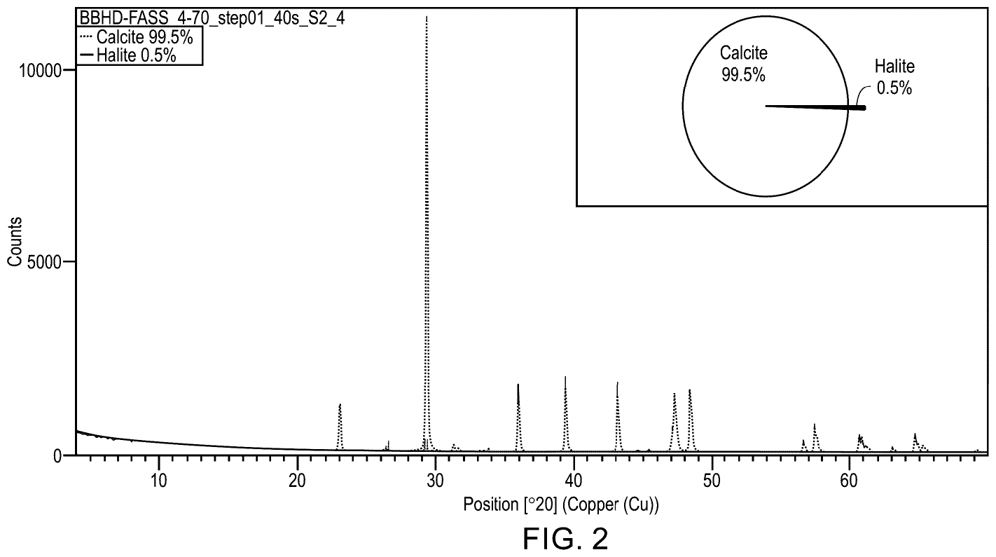

The precipitated salt was analyzed using X-ray diffraction (XRD) and its composition was found to be 99.5% calcite (CaCO₃) and 0.5% halite (NaCl). FIG. 2 shows an example XRD spectra of the precipitated salt. The precipitated salt displays high purity despite being precipitated from a produced brine sample. Additionally, an ion chromatography (IC) analysis of the sample before and after CO₂ mineralization is shown in Table 1. The results of the analysis showed that the concentration of calcium in the produced brine sample decreased from 6329 ppm to about 521 ppm, indicating that more than 90% of calcium ions present in the produced brine were mineralized as calcium carbonate salt. Further, the concentration of magnesium in the produced brine sample decreased from 1189 ppm to 745 ppm, indicating that CO₂ mineralization also reduced the amount of magnesium in produced brine. Accordingly, this protocol successfully softened produced brine through CO₂ mineralization.

TABLE 1
Ion Chromatography Analysis of Produced
Brine, Pre- and Post-treatment

Concentration (ppm)

| | Produced Brine | Softened Water |
|---|---|---|
| Component | (pretreatment) | (post treatment) |
| Chloride | 51475 | 51700 |
| Bromide | 726 | 725 |
| Sulfate | 1738 | 1363 |
| Sodium | 25165 | 25145 |
| Potassium | 16 | 14 |
| Magnesium | 1189 | 745 |
| Calcium | 6329 | 521 |

### Definitions

The term “about” as used in this disclosure can allow for a degree of variability in a value or range, for example, within 10%, within 5%, or within 1% of a stated value or of a stated limit of a range.

As used in this disclosure, the term “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact the material. Subterranean materials can include any materials placed into the wellbore such as cement, drill shafts, liners, tubing, casing, or screens; placing a material in a subterranean formation can include contacting with such subterranean materials. In some examples, a subterranean formation or material can be any downhole region that can produce liquid or gaseous petroleum materials, water, or any downhole section in fluid contact with liquid or gaseous petroleum materials, or water. For example, a subterranean formation or material can be at least one of an area desired to be fractured, a fracture or an area surrounding a fracture, and a flow pathway or an area surrounding a flow pathway, in which a fracture or a flow pathway can be optionally fluidly connected to a subterranean petroleum- or water-producing region, directly or through one or more fractures or flow pathways.

A number of implementations of the disclosure have been described.

Nevertheless, it will be understood that various modifications may be made without departing from the spirit and scope of the disclosure.

### Embodiments

1. A method for softening produced oilfield brine for enhanced oil recovery, the method comprising:
dissolving gaseous carbon dioxide (CO₂) in a produced oilfield brine, wherein the produced oilfield brine comprises divalent ions, to yield a CO₂ charged water;
adding a base to the CO₂ charged water to yield a basic CO₂ charged slurry, wherein the basic CO₂ charged slurry comprises solid carbonates;
filtering the basic CO₂ charged slurry to remove the solid carbonates to yield a softened water; and
injecting the softened water into a subterranean formation.

2. The method of embodiment 1, wherein the divalent ions comprise calcium ions.

3. The method of embodiment 1 or 2, wherein the solid carbonates comprise calcium carbonates.

4. The method of claim any one of embodiments 1-3, wherein the divalent ions comprise magnesium ions.

5. The method of any one of embodiments 1-4, wherein the solid carbonates comprise magnesium carbonates.

6. The method of any one of embodiments 1-5, wherein the base comprises NH₃OH, NaOH, Na₂[B₄O₅(OH)₄]·8H₂O, or Na₃PO₄.

7. The method of any one of embodiments 1-6, wherein the CO₂ charged water has a pH of between 3.8 to 4.8.

8. The method of any one of embodiments 1-7, wherein the basic CO₂ charged slurry has a pH of greater than 4.8.

9. The method of any one of embodiments 1-8, further comprising adding a catalyst to the basic CO₂ charged slurry.

10. The method of any one of embodiments 1-9, further comprising displacing oil in a subterranean formation with the softened water.

11. The method of embodiment 10, further comprising recovering the displaced oil from the subterranean formation.

1. A method for softening produced oilfield brine for enhanced oil recovery, the method comprising:
dissolving gaseous carbon dioxide (CO₂) in a produced oilfield brine, wherein the produced oilfield brine comprises divalent ions comprising divalent cations, to yield a CO₂ charged water, wherein the CO₂ charged water has a pH of between 3.8 to 4.8;
adding a base comprising Na₂[B₄O₅(OH)₄]·8H₂O or Na₃PO₄ to the CO₂ charged water to yield a basic CO₂ charged slurry, wherein the basic CO₂ charged slurry comprises solid carbonates;
filtering the basic CO₂ charged slurry to remove the solid carbonates to yield a softened water; and
injecting the softened water into a subterranean formation,
wherein the divalent cations are selected from calcium ions, magnesium ions, and combinations thereof.

2. The method of claim 1, wherein the divalent cations are calcium ions.

3. The method of claim 2, wherein the solid carbonates comprise calcium carbonates.

4. The method of claim 1, wherein the divalent cations are magnesium ions.

5. The method of claim 4, wherein the solid carbonates comprise magnesium carbonates.

6. (canceled)

7. (canceled)

8. The method of claim 1, wherein the basic CO₂ charged slurry has a pH of greater than 4.8.

9. (canceled)

10. The method of claim 1, further comprising displacing oil in the subterranean formation with the softened water.

11. The method of claim 10, further comprising recovering the displaced oil from the subterranean formation.

12. The method of claim 1, wherein the divalent cations present in the produced oilfield brine are calcium cations in an amount of within 10% of 6320 ppm.

13. The method of claim 1, wherein the divalent cations present in the softened water are calcium cations in an amount of within 10% of 520 ppm.

14. The method of claim 1, wherein the divalent cations present in the produced oilfield brine are magnesium cations in an amount of within 10% of 1180 ppm.

15. The method of claim 1, wherein the divalent cations present in the softened water are magnesium cations in an amount of within 10% of 740 ppm.
